(19) United States
(12) Patent Application Publication
(10) Pub. No.: US 2010/0160155 A1
(43) Pub. Date: Jun. 24, 2010

(54) Carbon Nanotubes with Nano-Sized Particles Adhered thereto and Method of Preparing Same

(76) Inventor: Kangning Liang, Bartlett, TN (US)

Correspondence Address: FROMMER LAWRENCE & HAUG, 745 FIFTH AVENUE- 10TH FL., NEW YORK, NY, 10151, US

(21) Appl. No.: 12/341,255

(22) Filed: Dec. 22, 2008

(51) Int. Cl. B01J 27/20; B32B 5/16; B05D 3/10

(52) U.S. Cl. 502/182; 428/323; 502/180; 427/336

(57) ABSTRACT

A carbon nanotube film is disclosed which includes a plurality of macroscopically aligned carbon nanotubes, and a plurality of nanoparticles which are adhered to the surfaces of the carbon nanotubes. A method for constructing a carbon nanotube film is also disclosed. This method includes multiple steps. First, a plurality of macroscopically aligned carbon nanotubes are formed on a substrate. Next, a solution including a dispersion of nanoparticles in a solvent is applied onto the carbon nanotubes. Then, the solvent is evaporated so that the nanoparticles remain and are adhered to the carbon nanotubes.

### BACKGROUND OF THE INVENTION

1. Field of the Invention

This invention provides an aligned carbon nanotube film with nano-sized particles adhered thereto and a method of preparing same. Such a film possesses a vast amount of surface area and excellent electrical conductivity along the alignment direction. This enables higher reactant flow rate and, in the case where the nanoparticles are catalysts, better contact between catalyst particles and reactants. Consequently, higher catalytic efficiency and productivity are can be obtained.

2. Description of Related Art

A supported catalyst is composed of one or more active components deposited on a solid carrier to achieve an optimal dispersion and to prevent sintering of the active components. In order to successfully design and obtain the appropriate catalyst for a given process, several aspects should be taken into account. Because of the complexity of the preparation process, it is unlikely to design a general procedure for this type of catalyst preparation. In other words, different catalytic properties might be desirable for each particular application, because the physical and chemical properties of a catalyst can be tightly related to the preparation procedure.

The carrier of a supported catalyst should possess a high surface area upon which a highly dispersed catalyst can be formed. It is naturally desirable that the catalyst particles display a narrow particle size distribution. Impregnation, ion exchange, anchoring, grafting, and heterogenization of complexes are among the most used methods for preparing heterogeneous catalysts.

Carbon has been extensively used as a carrier for metal or alloy catalysts. It is chemically inert and usually comes as nano-sized particles. The enormous surface area it possesses makes it a very good catalyst supporting material. Furthermore, carbon is electrically conductive, ensuring its widespread use in fuel cells as a catalytic carrier.

Compared to carbon, carbon nanotubes are potentially a better catalyst carrier material because of their outstanding electrical, mechanical, and structural properties. A carbon nanotube has an exceptionally large aspect ratio, big surface area, and superior electrical conductivity along the tube direction.

As such, there exists a need for a method and process resulting in carbon nanotubes with increased catalytic efficiency.

### SUMMARY OF THE INVENTION

In accordance with one embodiment of the invention, a carbon nanotube film is disclosed which includes a plurality of macroscopically aligned carbon nanotubes, and a plurality of nanoparticles which are adhered to the surfaces of the carbon nanotubes.

Pursuant to another embodiment of the invention, a method for constructing a carbon nanotube film is disclosed. This method includes multiple steps. First, a plurality of macroscopically aligned carbon nanotubes are formed on a substrate. Next, a solution including a dispersion of nanoparticles in a solvent is applied onto the carbon nanotubes. Then, the solvent is evaporated so that the nanoparticles remain and are adhered to the carbon nanotubes.

### BRIEF DESCRIPTION OF THE DRAWINGS

FIG. 1 illustrates a macroscopically aligned carbon nanotube film according to an embodiment of the invention.

FIGS. 2A and 2B depict images of the carbon nanotubes of Example 1 described below.

FIGS. 3A and 3B depict images of the carbon nanotubes of Example 2 described below.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

A macroscopically aligned carbon nanotube film possesses a vast amount of surface area and excellent electrical conductivity along the alignment direction. In addition, the aligned film provides channels for materials such as reactants, gases, and liquids to pass through with minimal obstruction along the alignment direction, enabling higher reactant flow rate and better contact between catalyst particles and reactants. Consequently, higher catalytic efficiency and productivity are resulted.

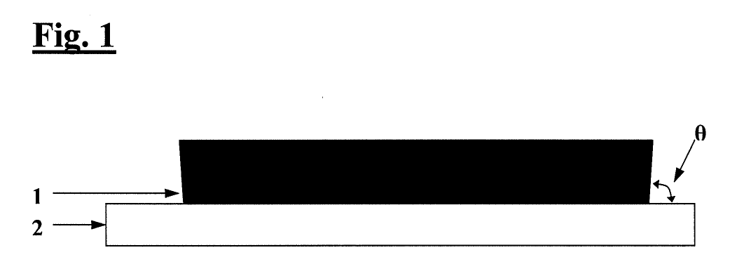

Such a macroscopically aligned carbon nanotube film is distinguishable from a macroscopically non-aligned carbon nanotube film. FIG. 1 illustrates a macroscopically aligned carbon nanotube film. In an aligned carbon nanotube film 1, the nanotubes are roughly all aligned, macroscopically, in the same direction. This direction is roughly perpendicular, within 10° of either direction, to the substrate 2 on which the nanotubes are grown. In other words, the angle between the length direction of the carbon nanotube film 1 and the substrate 2 is somewhere between 80° and 100°, inclusive. Such an aligned carbon nanotube film has the benefit of enabling good fluid flow in the direction of the length of the carbon nanotubes.

The above discussion of the arrangement of the carbon nanotubes relates to the macroscopic arrangement, as opposed to the microscopic arrangement. Microscopically, all carbon nanotubes appear to be jumbled. This is because, on the microscopic level, the carbon nanotubes are never perfectly aligned. However, if grown properly, the carbon nanotubes can be grown such that they are arranged to be aligned on the macroscopic level.

Such a design where the nanotubes are macroscopically aligned is different from that of a macroscopically non-aligned carbon nanotube film. In a macroscopically non-aligned film, the nanotubes are arranged at various angles and in various directions at the macroscopic level. In such a macroscopically jumbled arrangement of carbon nanotubes, the ability of fluid to travel between the nanotubes is greatly diminished from the arrangement where the carbon nanotubes are macroscopically aligned.

Due to the above listed benefits, the following embodiments use macroscopically aligned carbon nanotubes.

In one embodiment, a preformed nano-sized catalyst emulsion or microemulsion is spread in an aligned carbon nanotube film. The nano-sized catalyst solution can be an aqueous or non-aqueous solution. Examples of solvents for such solutions included isopropanol, oil and water emulsion, and hexane based solutions. What is important is that the solvent be sufficiently volatile so that the solvent can later be removed with relative ease. As such, any volatile hydrocarbon with a low boiling point may be used as a solvent in the nano-sized catalyst solution as well.

After the nano-sized catalyst solution is spread in an aligned carbon nanotube film, the volatile solvents are removed so as to allow the catalyst nano-particles to be absorbed onto the surface of carbon nanotubes to form a carbon nanotube-supported catalyst. The catalyst/carbon nanotube combination can be used in chemical syntheses, fuel cells, chemical conversions, or purifications, depending on the composition of the catalyst particles. Examples of catalysts that can be used include oxides (e.g., metal oxides), dioxides (e.g., silicon dioxide), metals (e.g., nickel), metal alloys.

In order to disperse the nano-sized catalyst particles into the aligned carbon nanotube film, the particles should be in the form of a stable liquid dispersion. For example, the particles can be in the form of a dispersion of nano-sized catalyst particles prepared using microemulsion and/or inverse micelle methods. As another example, nano-sized powder can also be dispersed into a fluid to form a stable dispersion, which can then be used to form a carbon nanotube film-supported catalyst.

If the fluid of the nano-sized catalyst particle dispersion is hydrophilic, it can be difficult for the fluid to penetrate into the interior of the carbon nanotube film. In this case, one or more surfactants are needed to improve the wetting ability of the dispersion on the carbon nanotube surface. The best surfactants to use in such a case are neutrally charged surfactants, as such surfactants are least likely to disturb the stability of the suspension. However, anionic or cationic surfactants can also be used, so long as the chosen surfactant does not cause the nanoparticles to fall out of suspension, thereby becoming unusable.

In other words, the main criterion for selecting a surfactant is that the chosen surfactant should not cause a degradation of the stability of the dispersion of the nanoparticles. For example, if the nanoparticle being dispersed is positively charged then you can use a positively charged or neutrally charged surfactant. Similarly, if the nanoparticle being dispersed is negatively charged, then you can use a negatively charged or neutrally charged surfactant.

Conversely, for a water-in-oil inverse micellar system, the hydrophobicity of such a dispersion would allow the dispersion to readily fill in the space between the carbon nanotubes without the need to add any surfactant.

After the carbon nanotube film has completely soaked up the catalyst particle dispersion, the solvents of the dispersion are then allowed to evaporate off of the film, leaving the catalyst particles adsorbed onto the carbon nanotube surface. One way of evaporating the solvents is to air dry the carbon nanotubes. Alternatively, the solvents can be evaporated by vacuum drying the carbon nanotubes. The carbon nanotubes can also be heated in order to evaporate the solvents. However, care must be taken no to heat the nanotubes too much, as this could destroy the integrity of the carbon nanotubes.

For the embodiments described above, an upright aligned carbon nanotube film is formed contiguously across the surface of the silicon substrate with the carbon nanotubes aligned in the direction perpendicular to the substrate surface. The carbon nanotube film can be grown on a piece of silicon substrate on which 20 to 200 Å of iron is deposited. The silicon piece is then put inside a carbon nanotube growth furnace. The growth process takes place at from 400 to 900° C., more preferably from 650 to 750° C., and most preferably around 700° C. At lower temperatures, the choice of catalyst for nanotube growth becomes important. For example, catalysts such as, for example, iron, cobalt, or nickel should be used at lower temperatures of, for example, around 400° C. In addition, tungsten may also be used as a catalyst. The growth process lasts from 5 minutes to 2 hours, more preferably from 10 to 50 minutes, and even more preferably around 20 to 30 minutes, with around 25 minutes being most preferable. The growth process occurs in a flow of mixed gasses typically including 100 sccm (standard cubic centimeters per minute) of hydrogen and 690 sccm of ethylene.

Alternatively, a different recipe can be used, in which the growth process occurs in a flow of mixed gases including 400 sccm of hydrogen, 400 sccm of ethylene, and 200 sccm of argon. The resulting carbon nanotube film shows that the carbon nanotubes have a length of about 150 to 600 microns and a diameter ranging from 20 to 40 nm. Other combinations of gases which may be used include ethylene alone, ethylene and ammonia, and ethylene and water vapor. The carbon gas listed above is ethylene, however other carbon gas may be subtitled therefore (e.g., methane, acetylene, etc.), provided the carbon gas is paired with a good matching catalyst.

After the growth process has taken place, the furnace is cooled down. Then argon is blown through the furnace to remove any carbon containing gases. The end product is then a “forest” of carbon nanotubes which are macroscopically aligned in the same direction.

It should be noted that there are different ways to apply the nano catalyst particle dispersion to the aligned carbon nanotube film. For example, an appropriate amount of the dispersion can be carefully dripped or sprayed onto the carbon nanotube film. If a greater amount of catalyst particles is desired to be adhered to the carbon nanotubes, this procedure can be repeated after the previously applied dispersion has dried. It should be noted that it is important to prevent the structure of the carbon nanotubes from being destroyed during the application of the nanoparticles. Accordingly, care should be taken when spraying a dispersion onto the carbon nanotubes so as to maintain the structure of the carbon nanotubes. If the dispersion is too sprayed with too much force, a hole might be poked through the carbon nanotubes, thus making them unusable. The carbon nanotube film can also be dipped into a dispersion of nano-sized catalyst particles, subsequently allowing the solvents to evaporate. Regardless of the process, the goal of applying any nanoparticle dispersion to the carbon nanotubes is to gently apply the dispersion so that the carbon nanotubes are fully saturated with nanoparticles, while maintaining the structural integrity of the carbon nanotubes.

### Example 1

### Aqueous Nano-Sized Silica Dispersion

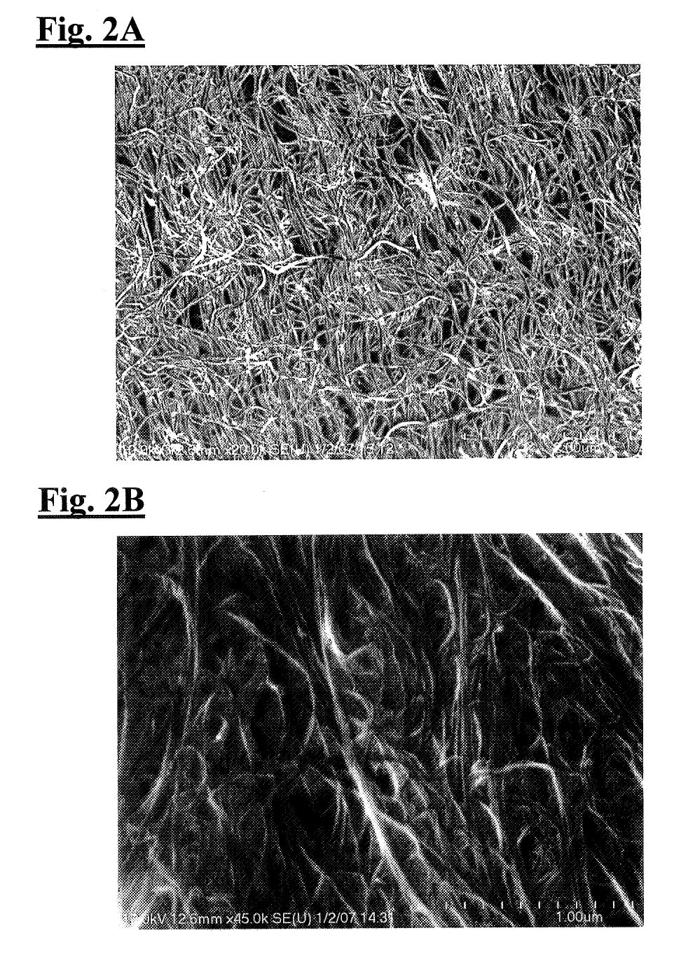

In Example 1, a few drops of an aqueous silica colloidal suspension, Snowtex-C, were added into 5 ml of deionized water to form a diluted suspension. Two drops of 10% Triton X-100 were added into the mixture, and the liquid was agitated until it was thoroughly mixed. A small amount of this solution (˜0.5 ml) was carefully spread over the surface of an aligned carbon nanotube film grown on a piece of silicon wafer (about 1 cm×2 cm). The film was then dried under ambient condition. FIGS. 2A and 2B depict images of the carbon nanotubes which were taken on a Hitachi S4700 scanning electron microscope. The silica particles can clearly be seen absorbed onto the carbon nanotubes as dark areas.

### Example 2

### Organic-Based Nano-Sized Silica Dispersion

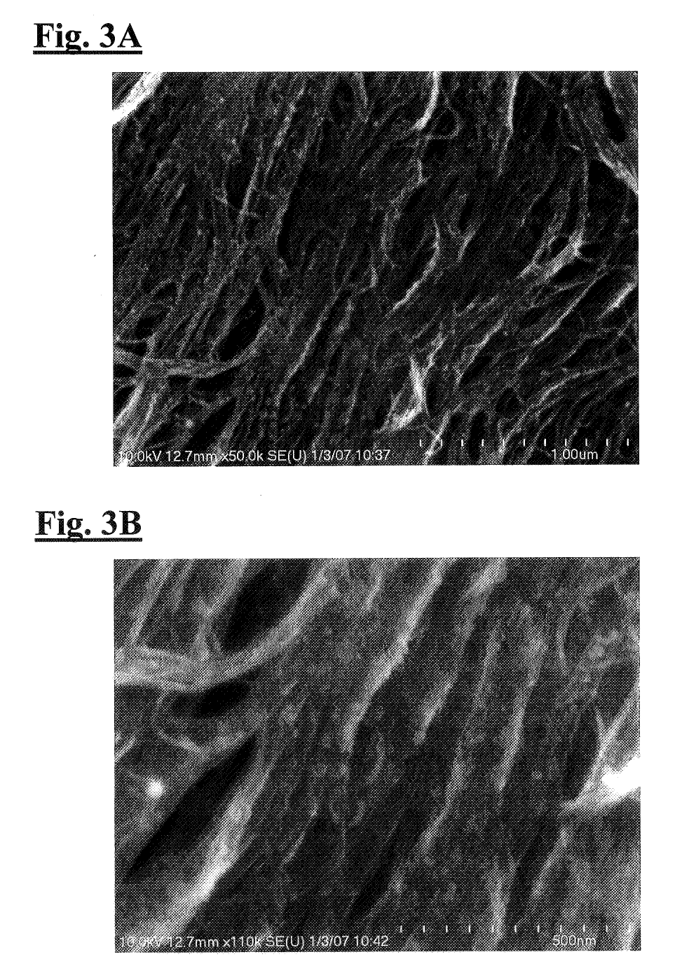

In Example 2, a few drops of an organic silica colloidal suspension, Snowtex IPA-ST, were added into 5 ml of isopropanol to form a diluted suspension. A small amount of this solution (˜0.5 ml) was carefully spread over the surface of an aligned carbon nanotube film grown on a piece of silicon wafer (about 1 cm×2 cm). The film was then dried under ambient conditions. FIGS. 3A and 3B depict images of the carbon nanotubes which were taken on a Hitachi S4700 scanning electron microscope. The silica particles can clearly be seen adsorbed onto the carbon nanotubes as dark areas.

While the above embodiments apply nano-sized catalyst particles to the carbon nanotubes, the invention is not limited thereto. Rather, any useful nanoparticle can be applied. For example, filtering particles can be applied so that the carbon nanotube combination can be used as a filter.

In addition, once the nanoparticles are applied to the carbon nanotubes and the solvent has evaporated, the carbon nanotubes can then be used for their intended purpose (e.g., used as a catalyst, used as a filter, used in fuel cells). For example, the carbon nanotubes can even be removed from the substrate if needed.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

What is claimed is:

1. A carbon nanotube film comprising:
a plurality of macroscopically aligned carbon nanotubes; and
a plurality of nanoparticles which are adhered to the surfaces of the carbon nanotubes.

2. The carbon nanotube film of claim 1;
wherein the nanoparticles include a catalyst.

3. The carbon nanotube film of claim 2;
wherein the catalyst includes an oxide.

4. The carbon nanotube film of claim 2;
wherein the catalyst includes a dioxide.

5. The carbon nanotube film of claim 4;
wherein the catalyst includes silicon dioxide.

6. The carbon nanotube film of claim 2;
wherein the catalyst includes a metal.

7. The carbon nanotube film of claim 2;
wherein the catalyst includes a metal alloy.

8. A method for constructing a carbon nanotube film, the method comprising:
forming a plurality of macroscopically aligned carbon nanotubes on a substrate;
applying a solution including a dispersion of nanoparticles in a solvent onto the carbon nanotubes; and
evaporating the solvent so that the nanoparticles remain and are adhered to the carbon nanotubes.

9. The method of claim 8;
wherein the solution is an aqueous solution, and further includes a surfactant which increases the wettability of the solution onto the carbon nanotubes without disturbing the suspension of the nanoparticles.

10. The method of claim 8;
wherein the solution is an non-aqueous solution

11. The method of claim 8;
wherein the solution is applied by dripping the solution onto the carbon nanotubes.

12. The method of claim 8;
wherein the solution is applied by spraying the solution onto the carbon nanotubes.

13. The method of claim 8;
wherein the solution is applied by dipping the carbon nanotubes into the solution.

14. The method of claim 8;
wherein the nanoparticles include a catalyst.

15. The method of claim 14;
wherein the catalyst includes an oxide.

16. The method of claim 14;
wherein the catalyst includes a dioxide.

17. The method of claim 14;
wherein the catalyst includes silicon dioxide.
